(19) United States
(12) Patent Application Publication
(10) Pub. No.: US 2004/0093258 A1
(43) Pub. Date: May 13, 2004

(54) Method and system for achieving small and intermediate market promotional penetration

(76) Inventors: Liv C. Lane, Minneapolis, MN (US); Kimberly L. Olson, Lakeville, MN (US); Mark W. Addicks, Minneapolis, MN (US)

Correspondence Address: GENERAL MILLS, P O BOX 1113, MINNEAPOLIS, MN, 55440, US

(21) Appl. No.: 10/289,929

(22) Filed: Nov. 7, 2002

(51) Int. Cl. G06F 17/60

(52) U.S. Cl. 705/10

(57) ABSTRACT

The present invention is directed to a method and system for achieving small and intermediate market promotional penetration, including public relations outreach programs and supplemental advertising. More specifically, the invention is directed to an automated mechanism for selecting appropriate markets that are outside of the traditional target of public relations and advertising agencies or large market areas for dissemination of promotional and product offerings to market segments that are typically not served by public relations departments and advertising agencies or firms.

### CROSS-REFERENCES TO RELATED APPLICATIONS

Not applicable.

1. Field of the Invention

The present invention is directed to a method and system for achieving small and intermediate market promotional penetration, including public relations outreach programs and supplemental advertising. More specifically, the invention is directed to an automated mechanism for selecting appropriate markets that are outside of the traditional target of public relations and advertising agencies or large market areas for dissemination of promotional and product offerings to market segments that are typically not served by public relations departments and advertising agencies or firms.

2. Background of the Invention

Marketing and the associated communications surrounding those efforts, such as advertising, merchandising and promotional campaigns, comprise a significant portion of the cost that is associated with bringing a product to the marketplace. The speed and accuracy at which the relevant communication or message is delivered is important in maintaining competitive lead times, building a loyal customer following and obtaining initial and then repeat purchases of products. Effective and timely delivery of those messages is important as manufacturers vie for limited retail shelf space in the retail and wholesale outlets frequented by consumers.

Advertising and marketing campaigns for consumer products can take many forms and some of the more common means to communicate the relevant message is simply to purchase space or time in the desired media outlet (e.g. television, radio, print). However, there are difficulties associated with such advertising and marketing campaigns and these include but are not limited to the time that is necessary to develop the campaign; the cost associated with releasing the campaign; determining the appropriate markets and demographics and so on. Even if all of the foregoing issues are resolved satisfactorily, then there are uncertainties associated with whether the campaign will be accepted by the target audience. Due to the expense and uncertainty involved in such advertising campaigns the more venues or audiences that can be exposed to the message, the better, as the more the manufacturer can communicate the message the more likely the manufacturer can spur interest in a product at the consumer level.

Another technique for promoting consumer products is through the use of public relations “press kits.” These kits contain press releases, premiums, incentives and their associated promotional collateral and related advertising indicia or merchandising items. As part of a product launch, promotional event or the initial rollout of an advertising campaign, this collection of information, premiums and other incentives are assembled together and put into kits (typically the kits include a container, package, compartment that is capable of holding the items that accompany the kit) that are then released to the editorial departments of pre-selected media outlets, such as television, radio, newspapers, magazines and the like. The kits may take the form of a unique shape, be personalized or other variation that compliments the product or promotion. Release of such kits provides those outlets with a chance to preview the materials and then discuss the product in their particular media outlet in the event that the media source finds the kits to be interesting and innovative. The theory behind the use of such kits is that a portion of the journalists, reporters, etc. that receive the kit will then discuss the new product in their particular forum. While the cost of such press kits or other similar public relations initiatives is generally less than large scale advertising campaigns, there can be more risk involved with such forums as the media outlet or recipient has no obligation to do or say anything about the consumer product. That is, participation in the campaign by the recipients or media outlet of the kits is purely voluntary.

Another problem with advertising, merchandising and marketing campaigns is, regardless of whether the campaign is based on contractual situations (where the manufacturer purchases advertising space in printed publications or time on television or radio) or a voluntary arrangement where public relations materials are released to media outlets, such programs are generally targeted at large markets, or “A” and “B” areas which tend to have significant population centers, such as New York, Chicago, Dalls/Ft. Worth, Atlanta, Minneapolis, Denver, Los Angeles and so on. While there is considerably more potential contact with consumers, as there are simply more consumers in these markets, largely one-third of the remaining consuming population available for purchasing the product remains unconnected with these messages, depriving the manufacturer of potentially significant feedback or view on their product offerings. The rationale for not pursuing markets outside the “A” or “B” type is that penetration of such intermediate and low population density markets, those markets usually classified as “C” and “D” level markets, can be quite expensive due to the large number of media outlets that need to be utilized to reach a significant number of the population. Said another way, each of the media outlets in the “C” and “D” markets reaches potentially significantly fewer possible consumers than each of the media outlets in the “A” and “B” markets.

A still further problem associated with missing such “mainstream” marketplaces is that the results of the marketing or advertising campaign can be skewed, providing a disproportionate interest in a product when only large market demographics are analyzed. This can often lead manufacturers to scale up production to provide delivery of these products not only to those large market areas, but also to the intermediate and small markets, based on the success of the marketing campaigns launched in larger markets or “A” and “B” markets. While trends may prove popular in those larger markets, such products simply may not meet the needs and demands of the small to intermediate marketplace or “C” and “D” markets.

Another problem associated with current marketing and advertising efforts can be simply waste. When communications materials are employed as part of the marketing campaign or other product premiums or incentives are made available for use in the program, often the manufacturer will order or produce a predetermined number of such kits or materials in anticipation of the needs or demands of the media outlet penetration. Typically, there are a number of kits or promotional items that are prepared that are not utilized during the campaign(s). Overproduction or a surplus of kits can manifest itself for a number of reasons including when distribution or demand does not meet expectation, or simply by ordering in volume, the manufacturer received a better purchase price in having the kits produced. Such surplus kits are then either discarded or sent off to a warehouse where they will ultimately be discarded and destroyed if no use can be made of the kits, such as through an expansion of the original program. If the kits contain perishable food items, then after a long period of storage, the only option is to discard the kits rather than donate the kits to a charitable organization. This situation creates unnecessary waste, not to mention the cost associated with disposal and storage of the unused kits.

Heretofore, the emphasis of such campaigns has generally been to target large population centers so that the message can reach as many people as possible. Therefore, what is needed is a system and a method that fulfills the needs of the manufacturer (to provide deeper product communication penetration) without incurring significantly more cost and expense in achieving that objective.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

The present invention describes a method and system through which manufacturers of consumer products are able to reach the small and intermediate markets without incurring great additional expense.

The system and method of the present invention uses a first data set that comprises demographic information about the population make up in a number of geographical areas consisting of small to intermediate markets. A second data set contains the types of media outlet sources that are available in the select market segments. A third data set contains the type of premiums and/or kits that are available for distribution. Manufacturers or clients then provide an indication of the type of demographic that the product is intended to reach and the system calculates and then locates the appropriate geographic area and the types of media outlets to employ. Once this is done, the system selects from the inventory of kits that are available and distributes the kits to the media outlets. The system further provides information and directions to the media outlet concerning the communication of the products and the kit contents.

In one exemplary embodiment of the present invention a system for achieving small to intermediate market public relations penetration, is described and includes at least first through fourth data sets. The first data set is populated with demographical information about selected geographical areas. The second data set is populated with information about media outlets servings the geographical areas. The third data set is populated with information about possible kits that are available for distribution to the geographical areas. The fourth data set populated with information about potential partners for inclusion in the program. The system of the present embodiment also includes a data comparator for selecting information from the first through fourth data sets in response to a request to create a program information set. The data comparator compares the program information set to information contained within at least one of the first through fourth data sets to obtain matches to the program information set. The system then distributes kits to the media outlets selected in the program information set and the system providing directions on use of said kits to said media outlets.

A still further embodiment of the present invention includes a method for increasing small to intermediate market exposure and comprises the steps of, first compiling at least first, second and third data sets. Then assembling potential partner information for use in the first data set. Then collecting demographic information for use in the second data set. The third data set is prepared by obtaining program format information for use in increasing small to intermediate market exposure. From the data sets, at least one data portion is selected to create a program having at least one partner, market and program format information. After the data portions have been selected at least one media outlet, that is relevant (located in or transmits or mails to) to at least a portion of the demographic information in the second data set is identified. After the identification of the media outlet, a kit is selected from an assortment of promotional kits, at least some of which have a premium and related indicia, related to at least one of the potential partners found in the first data set. Then the kit and related information is delivered to the media outlet located within the small to intermediate markets.

A further embodiment of the present invention relates to a method for increasing small to intermediate market penetration and comprising the steps of; initially collecting data through one or more collection devices for retention in a plurality of databases. Then initiating a program request to introduce consumer products to small and intermediate sized markets. Next, data contained in one or more of the plurality of databases is compared to determine compatible requirements with the program request. Once suitable data emerges one or more small to intermediate markets for program introduction is selected. Then the demographics from the small to intermediate markets is compared with the compatible requirements to create a program format; and finally, the program format is released to the small to intermediate markets through one or more media outlets.

A yet still further embodiment of the present invention relates to a system for increasing small to intermediate market exposure and includes at least one collection device for collecting data suitable for inclusion in a database. A plurality of databases, each receiving information from said at least one collection device and each of said plurality of databases containing different information. At least some of the information relating to small to intermediate market demographics, potential partners and program parameters. The system also includes a data comparator computer for comparing data selected from the plurality of databases in response to one or more queries to determine compatibility. The system also contemplates the use of a promotional kit that is selected for use in the program parameter. The promotional kit containing information related to the potential partners. The system releases the promotional kit is to small to intermediate markets that were chosen by the program parameters in order to increase product exposure in those markets.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a schematic diagram of an exemplary illustrative system;

FIG. 2 shows a high level exemplary diagram for the partner database;

FIG. 3 shows a high level exemplary diagram for the market database;

FIGS. 4a through 4c shows an overall high-level exemplary illustrative flow diagram of a presently preferred exemplary embodiment;

FIG. 5 shows a high level exemplary diagram for the kit creation database;

FIG. 6 is an exemplary view of a system used to collect information for use in the database or data sets and a calculator to determine fit of multiple data sets or databases; and

FIG. 7 is an exemplary figure showing a system for collecting feedback for the program in response to the kit distribution.

### DETAILED DESCRIPTION OF THE INVENTION

The present invention is now illustrated in greater detail by way of the following detailed description, but it should be understood that the present invention is not to be construed as being limited thereto.

Surprisingly, it has been found that providing such small to intermediate markets, “C” and “D” markets, with some level of product promotion from the retail distributor or manufacturer, that effort can generate higher interest levels in a manufacturer's commercial offering and thus increase sales of those products. It has been found that media outlets in such markets genuinely appear to appreciate the effort taken by the manufacturer to circulate the products among these small market and semi rural populations.

The term “kits” as used herein includes prize packages, media kits, premium offerings, communication materials, consumer shipments, product information, combinations of any of them and the like.

The term “premium” as used herein and which is included either within the kits or in accompaniment with the kits, that is auxiliary thereto, and may include coupons good toward the purchase of retail goods and/or services, clothing such as tee shirts, hats, etc. that illustrate or carry the brand name of the product being promoted, premiums such as toys, watches, software, etc. which again would carry the brand name of the product being promoted and other incentives and combinations and the like.

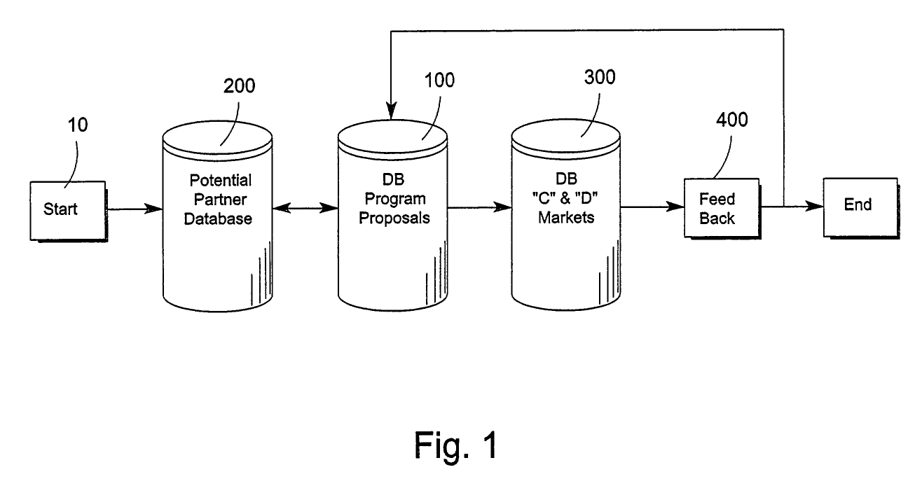

In one exemplary embodiment of the present invention, FIG. 1 provides a high level flow diagram. Further, description on each of the process steps and modules of the present invention will be described in detail below. Once the system and method of the present invention are initiated 10, a selection of potential partners is made from the potential partner database 200 according to certain criteria. The selection is based on the parameters of the program proposal that is chosen from a program proposal database 100. Once a pool of potential partners has been selected, the partners may then be offered the opportunity to review the “C” and “D” markets that have been identified for the upcoming promotional launch. Partners may opt in or out depending upon what is present in the particular marketplace being presented and the program being utilized to penetrate the market.

Each of the selected partners is then allowed to purchase or choose designated slots for participation in the program. Designated slots as used herein may include hours of the day, days of the week, months of the year, , geographic or demographic regions combinations of these and the like. Once each partner has chosen a slot in which to participate, a matrix is created and the placement of the partners and the particular kit to be provided in connection with each slot selection is illustrated. Preferably, a different partner is provided in each slot so as to provide the media outlet with “fresh” kits to distribute to its subscribers or audience in each slot. This makes the system less repetitive in its application thereby keeping interest high. However, where a partner would prefer to use successive slots, the system can accommodate that request.

For example, if one of the partners is General Mills, of Minneapolis, Minn., one slot may be allocated for BETTY CROCKER® products. The promotional kit may include cooking utensils, clothing and accessories, such as aprons, and ready to eat as well as shelf stable food products. Another slot may be filled by the relevant CHEERIOS® business unit in which CHEERIOS® merchandise may be given away possibly in connection with a joint promotion with NASCAR®. Alternatively, food products, and branded clothing and children's toys could be included in the distribution. In other slots POP SECRET® popcorn could be provided in kits as well as samples of BUGLES® and WAHOOS® salty snacks.

In order to qualify for the program that is proposed the partners need to meet criteria that have been chosen in the hopes of making the program successful. Once the program proposal database 100 has selected a program and partners from the potential partner database 200, the program is released to the small to intermediate markets or “C” and “D” markets. The “C” and “D” markets are chosen again based on certain criteria and are contained in a market database 300. After the program is released to the “C” and “D” markets, feed back is collected by a number of means at feed back module 400 and circulated back to the program proposal database 100 for use in formulating programs at a later date.

It should be understood that the program may be released to only certain segments of the “C” and/or “D” marketplace or only to one of the “C” or “D” markets and various combinations thereof.

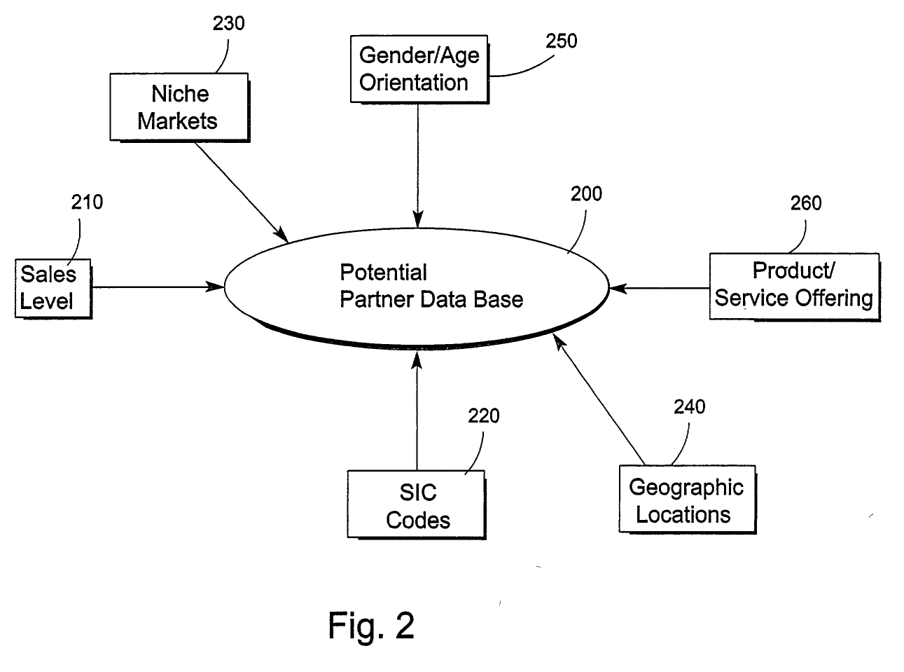

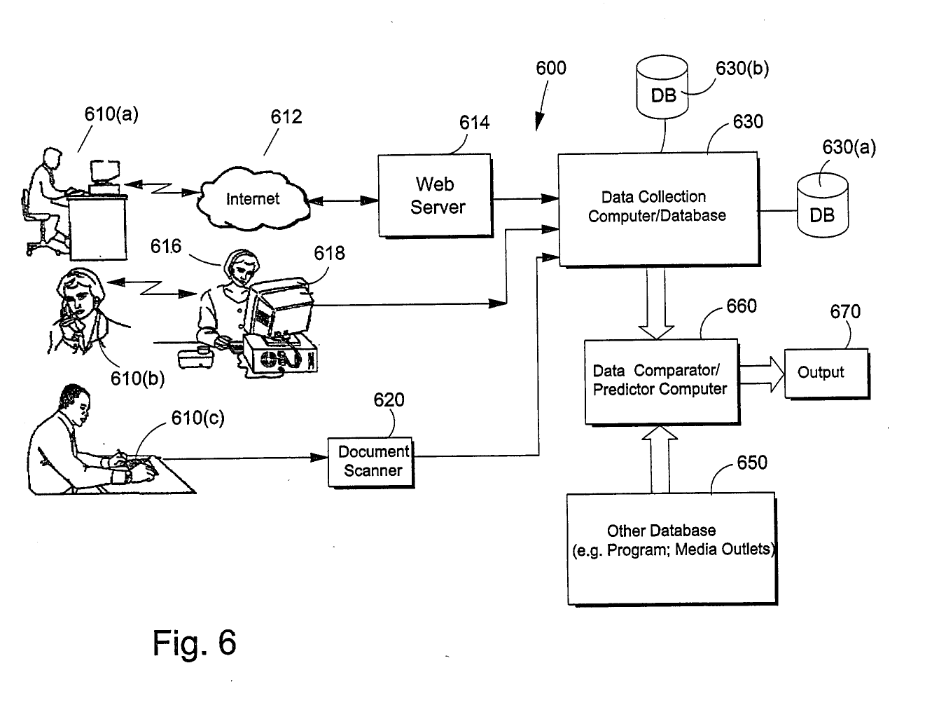

Turning to FIG. 2, a number of potential partners, product manufacturers or distributors are selected are selected from a first database 200 that is created by surveying the market for interested parties. The surveys may be conducted in any number of fashion, including over the Internet, at trade show and industry gatherings, direct mail solicitations, meetings and conferences, combinations thereof and the like as will be further discussed in FIG. 6 below. The partners are then chosen according to certain criteria that may be complimentary to the sponsor of the program. This criterion may include but is not limited to such categories as annual sales levels 210, SIC codes 220, niche market offerings 230, geographic locations 240 and other demographic information 250, product or service orientation or focus 260, such as gender applicable products, combinations of these and the like.

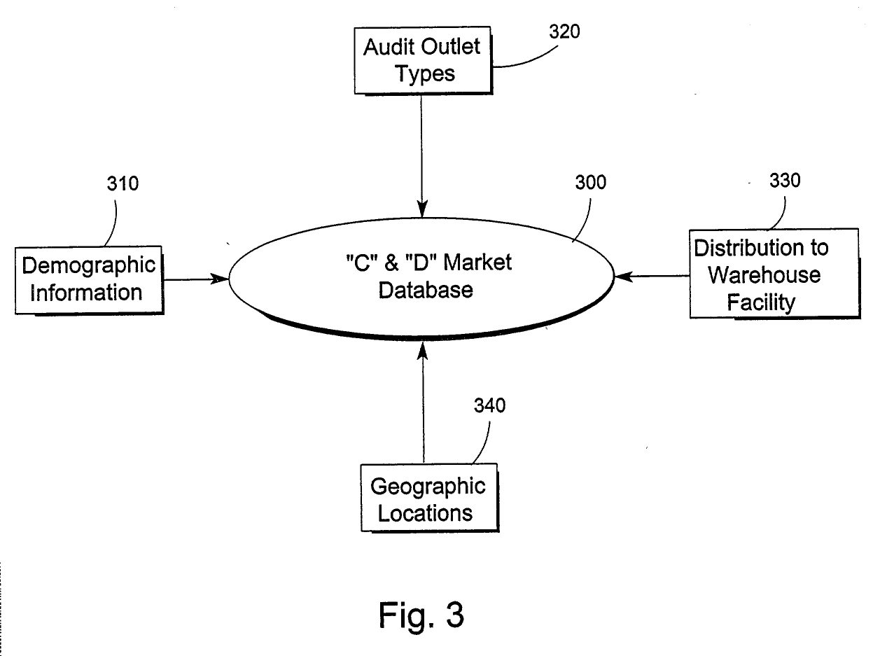

The small to intermediate markets that are suitable for the upcoming program are pre-determined, categorized and ranked and contained in a second database 300, which is illustrated in FIG. 3. The information pertinent to each of the “C” and “D” markets may include various demographic elements 310 such as population size, age of the population, gender make-up, education and skill level and the like as well as logistical information such as the number and type of media outlets 320 serving the marketplace, distribution and warehousing facilities 330 and geographic location.

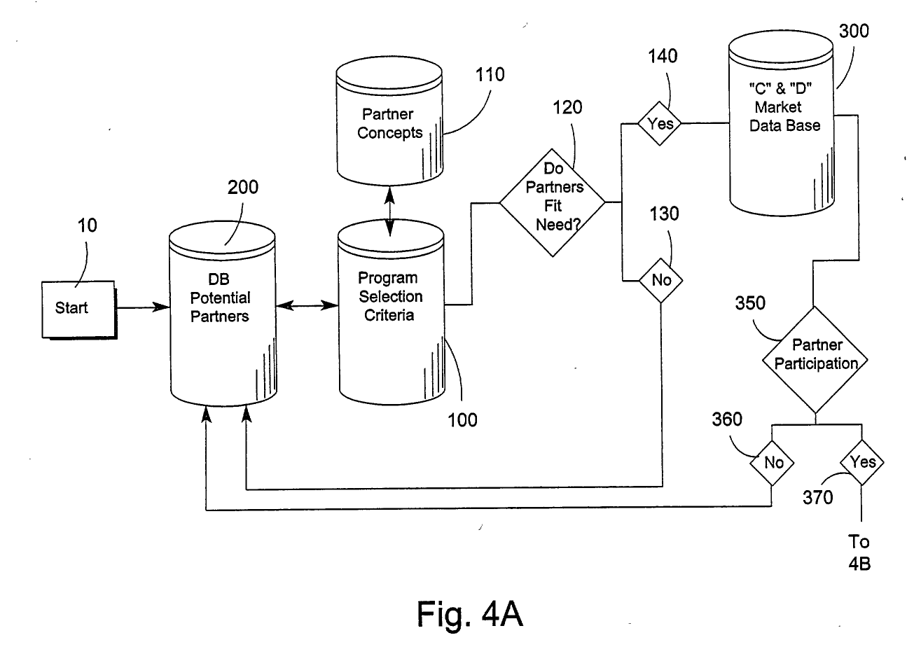

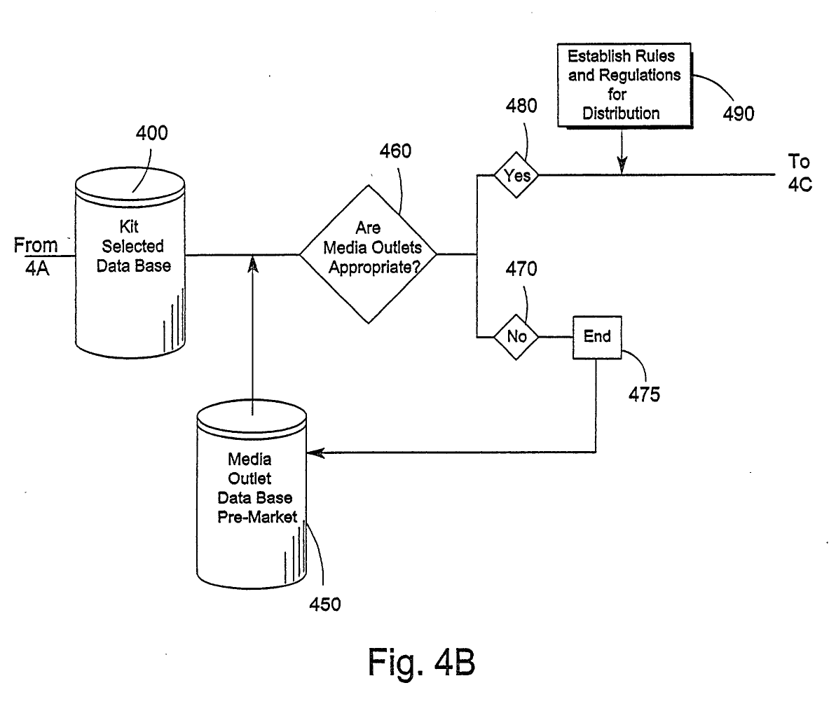

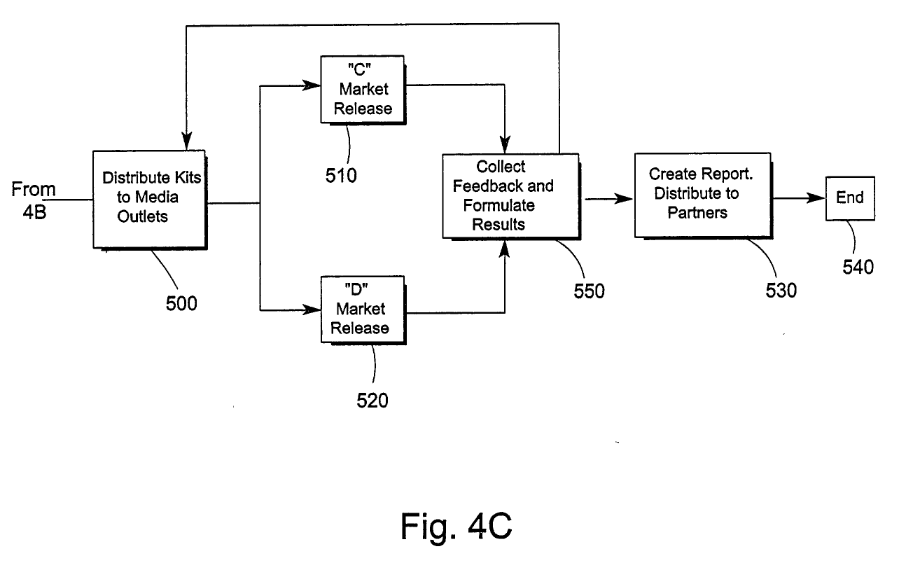

The present invention is now illustrated in greater detail by referring to FIGS. 4A through 4C. The system and method of the present invention is initiated 10 and begins with sorting potential partners from the potential partner database 200 described above with reference to FIG. 2. The selection of possible partners from database 200 is done through an initiation sequence created by program selection database 100. The program initiation sequence can be created internally by the program operator or manager in light of certain requirements or needs, or can be based on an external inquiry as to program availability from a potential partner. The program database 100 contains a listing of historical program information and performance of those programs as well as program concepts that are stored in a further database 110.

Once the program has been identified, it is refined or adjusted to cover the need of the inquiry that prompted the program initiation sequence. Next, a potential grouping of partners is determined and the potential partners are queried 120 as to whether the program is of interest to the partners. The system then calculates or predicts the likelihood of possible partner interest in participating in the program information set (see FIG. 6 and discussion related thereto). If the partner decides that the program is not of interest 130, the partner's name is removed from the program opportunity and returned to the potential partner database 200 with an updated listing that records the partners preference(s) with respect to the type of program(s) presented. While the present illustrative embodiment describes only a signal program offering, it should be understood that multiple program offerings could be produced at the initiation sequence.

Should the partner elect an affirmative response 140 to proceed with the program, the program then seeks to ascertain relevant markets for the program through the use of the “C” and “D” market database 300. The “C” and “D” market databases is created as described above in connection with reference to FIG. 3. The system then calculates or predicts 350 again whether the parameters established by the partner meet the program information set and whether there is a desire to proceed 370 or to withdraw from the program 360 (see illustrative embodiment provided in FIG. 6). If the partner elects to withdraw from the program 360, the partner name is returned to the potential partner database 200 for future use and again the partner information is updated to reflect the particular decision(s) that the partner made with respect to the interest in the program(s) and disinterest in the marketplaces that were selected.

After the partners, program and markets have been selected through use of databases 200, 100 and 300 respectively and the partners polled at predefined stations 120 and 350, the kit for the program is chosen through the use of various selection criteria resident in kit database 400.

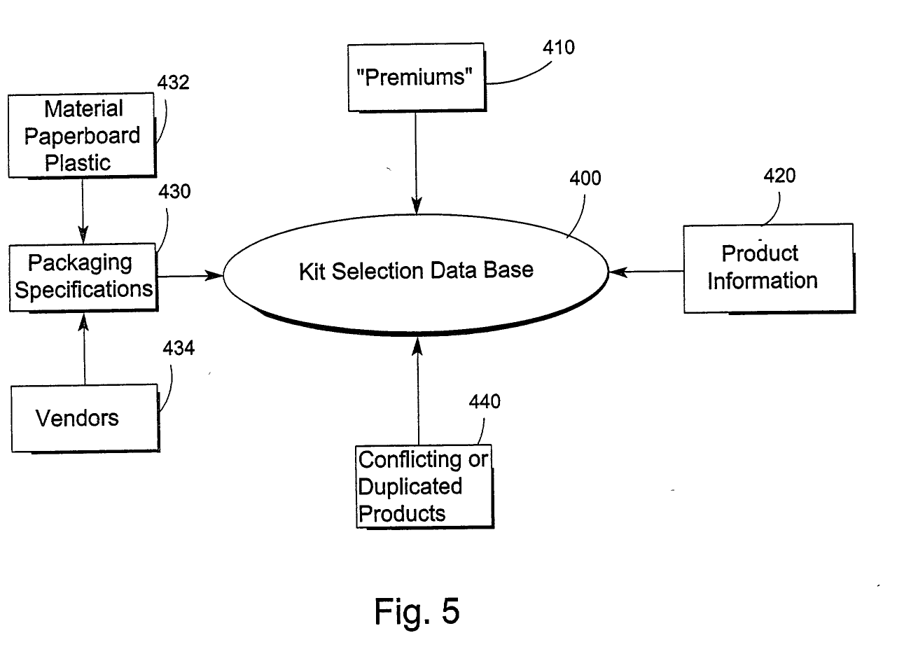

Turning briefly to FIG. 5, the kit database 400 is created through the use of a listing of premiums 410 as defined above, related product or service information 420, packaging specifications 430 that are available for the kit and a cross reference data set 440 that lists conflicting or duplicative products or offerings. The packaging specification data set 430 may include such information as available materials 432, such as paperboard, plastic, etc. and a listing of vendors 434 that can supply such packaging materials or information. The product or service information 420 may be printed, contained in various pre-recorded formats such as CD ROMS, diskettes, videotapes and combinations and the like.

After the kit selection 400 step is completed, the system employs a further database 450 that contains information relating to the media outlets that are available for use in distributing the program in the selected market areas. The program compares the needs of the program and the kits to be distributed at step 460 with the information from the media outlet database and then calculates or predicts the requirements for the program and whether there is sufficient inventory to meet the needs of the program information set. If there are insufficient, inadequate or the media outlets do not fit the needs or requirements of the promotional program or kit, then the program is rejected at step 470 and the process comes to an end at 475 with appropriate feedback going to update the media outlet database 450.

If there are adequate media outlets and related resources, the program is accepted at step 480. Prior to releasing the promotional program kits to the media outlets, rules and regulations 490 are included as part of the kit and the again the system calculates or predicts the type of rules or regulations that are suited for the particular program set. The rules and regulations provide information on eligibility if sweepstakes or other information is included in the package, distribution requirements for the media outlets, guidelines for returning or disposing of residual package pieces and other information relevant for the participation of the media outlets in the market segments.

The rules and regulations module 490 may also formulate a communication message that is acceptable to each of the participants and relevant to the kits being presented.

After the rules and regulations 490 are incorporated along with the promotional kit offering, the promotional kits are then distributed to the media outlets at step 500 for distribution to the respective subscribers, listeners, viewers, etc. of the media outlet in one or both of the target markets “C” and “D”, 510 and 520 respectively.

After the distribution of the kits has been completed, the media outlets provide confirmation that the communication message was delivered. This confirmation may take many forms, including but not limited to recorded audio and or videotapes of the communication message made by the media outlet, or copies of printed publications where the message was distributed via a print medium.

Turning now to FIG. 6 an illustrative system is provided for exemplary discussion of the collection of data for use in the data sets or databases and then a data calculator or predictor computer is used to merge the information from multiple data sets or databases to achieve a particular result as provided in FIGS. 4A through 4C.

Referring to the FIG. 6 system 600 includes various data collection mechanisms 610 (e.g., networked personal computers and other Internet appliances 610(a), telephone 610(b), and data entry forms 610(c), for example) that are used to collect data relating to the particular data set or database being created. As an example, if the potential partner data set is being created, the information collected may include but is not limited to such categories (referring to FIG. 2) as annual sales levels 210, SIC codes 220, niche market offerings 230, geographic locations 240 and other demographic information 250, product or service orientation or focus 260, such as gender applicable products, combinations of these and the like. As shown in FIG. 6, these various mechanisms 610 use different data transmission paths (e.g., the Internet 612 and associated web server 614 in the case of web appliance 610(a); a telephone operator 616 entering data in a data entry terminal 618 in the case of telephonic interviews using telephone 610(b); and document scanner 620 in the case of filled-in forms 610(c)) to collect data and provide it to a data collection computer/database 630. In creation of the database 630, the database may draw on other stored information, which may be present at the same location 630(a) as the database 630 or may be remotely obtained through a subscription service or the like 630(b). The mechanisms shown in FIG. 6 are not exhaustive—other conventional ways of gathering data are known and any such techniques may be used.

Once the data sets or databases 630 are created (referring to the previous figures databases or data sets 100, 200, 300, 400, 450, 490) they are fed to a data comparator or predictor computer 660 based on a sequence wherein for example a listing of partners is requested. The predictor computer 660 then merges the information with other information provided from other databases or data sets 650 that were established or collected in the same manner. The predictor computer 660 then provides an output 670, and referring to FIGS. 4A through 4C, the output 670 may include steps 120, 350, 460 for example.

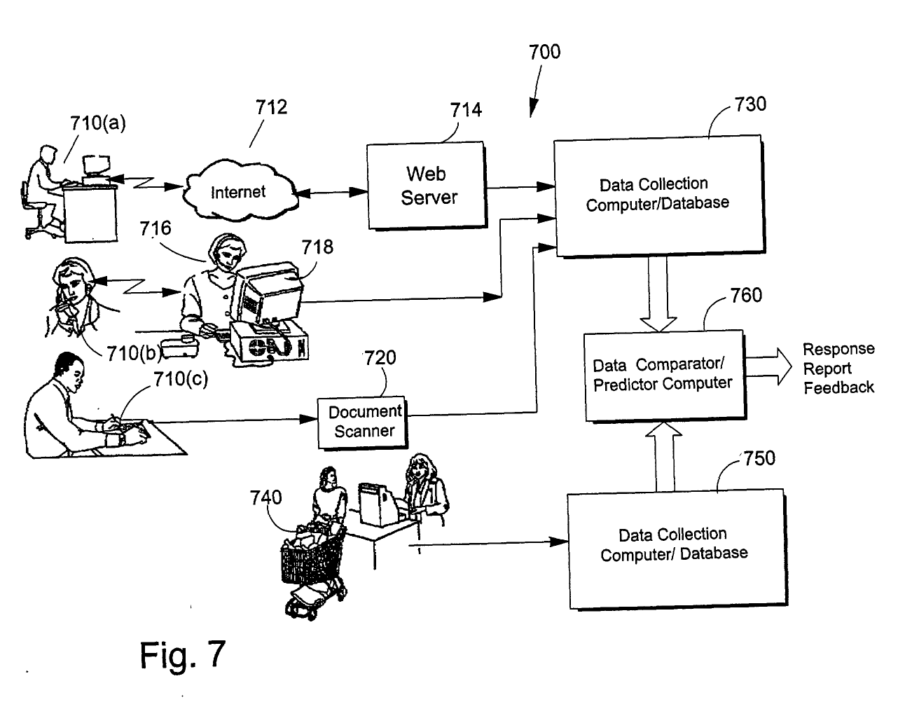

Turning now to FIG. 7, a similar schematic is provided to illustrate an exemplary system to collect and provide response feedback based on information that may have been contained in the kits that were distributed as part of the program.

Referring to the FIG. 7 feed back collection system 700 includes various data collection mechanisms 710 (e.g., networked personal computers and other Internet appliances 710(a), telephone 710(b) (which may include a tape recorder to record conversations), and data entry forms 710(c), for example) that are used to collect data relating to the particular database being created for the program. As shown in FIG. 7, these various mechanisms 710 use different data transmission paths (e.g., the Internet 712 and associated web server 714 in the case of web appliance 710(a); a telephone operator 716 entering data in a data entry terminal 718 in the case of telephonic interviews using telephone 710(b); and document scanner 720 in the case of filled-in forms 710(c)) to collect data and provide it to a data collection computer/database 730. In addition, checkout scanners 740 can be provided to collect information on coupons for the products or services being redeemed. The mechanisms shown in FIG. 7 are not exhaustive—other conventional ways of gathering data are known and any such techniques may be used.

Once the response or feedback data sets 730 is created the information is fed to a data comparator or predictor computer 760 based on a sequence wherein for example a partner has requested details on consumer acceptance or feedback redemption rates for the coupons. The predictor computer 760 then merges the information with other information provided from other databases or data sets 750. The predictor computer 760 then provides an output in the form of a response report or other feedback requested by the partner or program manager.

The promotional kits may contain information (response materials) by which the recipient can provide feed back either to the media outlets 500, at a central distribution center or other location which can then be passed along to the program manager or alternatively, the feedback can be collected, reviewed and formatted as appropriate at module 550 for distribution back to the potential partners 530 selected at database 200.

Such response materials may include a questionnaire concerning the likes and dislikes of the kits, information about how the kit was to be distributed and the communication message associated with the kit and other information and questions that the partner may believe is useful in the marketing of its products. That response material is then compiled by the program sponsor and a report prepared in connection with the confirmation from the media outlet and the response results.

After the feedback has been distributed the process for the program ends 540. Through an additional calculation module the system calculates the results collected as part of the feed back process.

It will thus be seen according to the present invention a highly advantageous system and method for achieving small and intermediate market penetration has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A system for achieving small to intermediate market public relations penetration, comprising;
at least first through fourth data sets;
said first data set populated with demographical information about selected geographical areas;
said second data set populated with information about media outlets servings said geographical areas;
said third data set populated with information about possible kits that are available for distribution to said geographical areas;
said fourth data set populated with information about potential partners;
a data comparator for selecting information from said first through fourth data sets in response to a request to create a program information set; said data comparator comparing said program information set to information contained within at least one of said first through fourth data sets to obtain matches to said program information set; and
wherein said system distributes kits to said media outlets selected in said program information set and said system providing directions on use of said kits to said media outlets.

2. A system as recited in claim 1, wherein said system collects consumer data in response to consumers within said geographical areas receiving said kits.

3. A system as recited in claim 1, wherein said system includes a fifth data set that contains rules and regulations pertaining to distribution of the kits.

4. A system as recited in claim 1, wherein said system further includes a response feed back collection system to collect and distribute feedback to the potential partners.

5. A system as recited in claim 1, wherein said data comparator updates information in at least one of said first through fourth data sets based on responses received from querying from said one of said first through fourth data sets.

6. A system as recited in claim 2, wherein said consumer data is collected by telephone, surveys, forms, scanners, web appliances and combinations thereof.

7. A method for increasing small to intermediate market exposure, comprising the steps of;
compiling at least first, second and third data sets;
assembling potential partner information for use in said first data set;
collecting demographic information for use in said second data set;
preparing said third data set by obtaining program format information for use in increasing small to intermediate market exposure;
selecting at least one data portion from each of the first, second and third data sets to create a program having at least one partner, market and program format information;
identifying at least one media outlet, said media outlet being relevant to at least a portion of said demographic information in said second data set;
providing an assortment of promotional kits related to at least one of said potential partners found in said first data set, at least some of said kits containing at least a premium and related indicia;
choosing one of said kits from for use in said program; and
delivering said one of said kits to said media outlet located within the small to intermediate markets.

8. A method for increasing small to intermediate market exposure as recited in claim 7, including a further step of after delivering said kits to said media outlet soliciting a response from the small to intermediate market demographic.

9. A method for increasing small to intermediate market exposure as recited in claim 8, including a further step of after delivering one of said kits to said media outlets then providing feedback to said at least one partner based on the response received.

10. A method for increasing small to intermediate market exposure as recited in claim 7, including a further step of after choosing one of said kits providing rules and regulations governing distribution of said kits by said media outlets.

11. A method for increasing small to intermediate market exposure as recited in claim 7, including a further step of after selecting the data portion then comparing at least one of said first through third data sets to another of said first through third data sets to determine compatibility in said program.

12. A method for increasing small to intermediate market exposure as recited in claim 11, including a further step of after comparing said data portion, then updating said data portion for later use.

13. A method for increasing small to intermediate market penetration, comprising the steps of;
collecting data through one or more collection devices for retention in a plurality of databases;
initiating a program request to introduce consumer products to small and intermediate sized markets;
comparing data contained in one or more of said plurality of databases to determine compatible requirements with said program request;
selecting one or more small to intermediate markets for program introduction;
comparing demographics from said small to intermediate markets with said compatible requirements to create a program format; and
releasing said program format to said small to intermediate markets through one or more media outlets.

14. A method for increasing small to intermediate market penetration as recited in claim 13, wherein said data is collected by telephone, surveys, forms, scanners, web appliances and combinations thereof.

15. A method for increasing small to intermediate market penetration as recited in claim 13, wherein said program format includes a kit containing a premium and related product information.

16. A method for increasing small to intermediate market penetration as recited in claim 13, including a further step of after comparing said data, then updating said data for retention in at least one of said plurality of databases.

17. A method for increasing small to intermediate market penetration as recited in claim 13, including a further step of after releasing said program format, then collecting consumer data from recipients of said program format.

18. A method for increasing small to intermediate market penetration as recited in claim 17, wherein said consumer data is reported back to program participants contained within one of said plurality of databases.

19. A method for increasing small to intermediate market penetration as recited in claim 13, wherein said plurality of databases includes information on potential program participants, small and intermediate market demographics, program proposals, rules and regulations for use with programs and combinations thereof.

20. A system for increasing small to intermediate market exposure, comprising;
at least one collection device for collecting data suitable for inclusion in a database;
a plurality of databases, each of said plurality of databases receiving information from said at least one collection device and each of said plurality of databases containing different information, at least some of said information relating to small to intermediate market demographics, potential partners and program parameters;
a data comparator computer for comparing data selected from said plurality of databases in response to one or more queries to determine compatibility;
a promotional kit selected for use in said program parameter, said promotional kit containing information related to said potential partners; and
wherein said promotional kit is released to small to intermediate markets chosen by said program parameters to increase product exposure in said markets.
